(19) United States
(12) Patent Application Publication
(10) Pub. No.: US 2010/0255173 A1
(43) Pub. Date: Oct. 7, 2010

(54) INSTANT NOODLES

(75) Inventors: Ryszard Przygodzki, Poznan (PL); Eugeniusz Korbas, Poznan (PL); Maria Jezewska, Poznan (PL); Iwona Blasinska, Poznan (PL); Irena Jozwiak, Poznan (PL); Piotr Lyskawa, Poznan (PL)

Correspondence Address: OLIFF & BERRIDGE, PLC, P.O. BOX 320850, ALEXANDRIA, VA, 22320-4850, US

(73) Assignee: INSTYTUT BIOTECHNOLOGII PRZEMYSLU ROLNO- SPOZYWCZEGO, WARSZAWA (PL)

(21) Appl. No.: 12/452,271

(22) PCT Filed: Dec. 19, 2008
(86) PCT No.: PCT/PL2008/000097

§ 371 Date: May 28, 2010

(30) Foreign Application Priority Data
Dec. 28, 2007 (PL) P 384179

(51) Int. Cl. A23L 1/162; A23L 1/308

(52) U.S. Cl. 426/557

(57) ABSTRACT

The instant noodles, containing flour or a mix of flours and possibly salt, include from 0.5 to 3.0 weight percent of the dietary fibre preparation, that has the fibres of the maximal length 400 micrometers, favorably to 250 micrometers, but at the same time about 90% percent of the fibres are of length under 120 micrometers.

The subject-matter of the present invention are the instant noodles.

The instant noodles are dried or precooked noodles fused with oil, and often sold with a packet of flavoring. Dried noodles are usually eaten after being cooked or soaked in boiling water for 3 to 5 minutes, while precooked noodles can be reheated, or eaten straight from the packet. Although similar products were available in dynastic China, modern instant noodles were invented by Momofuku Andō of Nissin Foods.

The instant noodles are, according to the know state of the art, manufactured from the wheat flour and additional ingredients, often the chemical substances, which increase the speed of preparation, also help to achieve the correct texture and are necessary to the persistence of the product. There are used the food additives and ingredients like e.g.: sodium, ammonium and potassium carbonates, disodium phosphate, tertiary butylhydroquinone (TBHQ), butylated hydroxyanisole (BHA), glycerol stearate, guar gum, riboflavin, sorbitol, egg powders, milk proteins, gluten, frying medium (oils).

The ingredients of the most common instant noodles are not favorable to proper nutrition and health. Those noodles are also inconvenient in preparation for eating. They require mainly the thermal processing, most often by flooding in the boiling water and leaving under the cover. Their disadvantage is also the limited use, because there are good only for concentrated dishes like ready-to-eat soups.

The Polish patent No. 193390 presented the method of manufacturing the instant noodles, that can be prepared for eating by rehydration, without providing the thermal processing, but they need for rehydration ½ hour. Moreover, the formation of the uniform texture, that guarantees proper consistency of the noodles after the product is prepared for eating, requires precise process conditions and selected flour.

The aim of the present invention are the instant noodles that have ability to dehydration in a cold water, and to keep good quality after the hydration.

Nature of the present invention lies in the instant noodles, which contain flour or a mix of flours and possibly salt, contain also from 0.5 to 3.0 weight percent of dietary fibre preparation, that has particle size of the maximal length 400 micrometers, favorably to 250 micrometers, but at the same time about 90% percent of the fibres are of length under 120 micrometers.

The noodles according to the invention have exceptional ability to rehydration, which is due to their inner structure—even, porous, and of high density. The structure is formed by the protein—starch compound with the net of the dietary fibres. These fibres create the 3 dimensional micro reinforcement, which support the net system of the protein—starch structure. This causes the better stability of the texture and the better absorption properties for liquids. Moreover, the dietary fibres have ability to capillary liquid bond, what additionally improves water—absorbing property of the product.

It was stated, that the presence of the dietary fibres in noodles' composition compensates for the variation of the flour quality. The elaborated composition enables to produce the suitable quality of the instant noodles, from the high protein flour as well as the low protein flour. Moreover, it possible to manufacture the instant noodles according to the invention from the low gluten flour and even from the gluten free flour, for those who suffer from celiac disease.

The instant noodles according to the invention characterize in that they are very convenient in preparation for eating—by pouring the water or another food liquid of the ambient temperature, or even the cold liquid, without the necessity of providing the heat. This property of the instant noodles makes the product environment friendly, because of the water and energy economy and the lack of CO₂ emission to the atmosphere. Hydrated noodles characterize in even consistency, without the hard parts as well as too soft parts.

The invented instant noodles have additional advantage in comparison to the instant noodles according to the state of art—unexpectedly it turned out, that the noodles prepared for eating in the water of the ambient temperature or in cold water, do not get stuck together, otherwise than the known instant noodles, which most often have to be prepared in the boiling water, then they stick together as a result of the starch gelatinization. The instant noodles can be used for the purpose of cooking, for preparation of the everyday food, for warm or cold dishes, they are perfect for salads and desserts, including the application in food industry.

The instant noodles according to the invention can be produced in many kinds, depending on using different corn mixes, like for example wheat noodles, buckwheat noodles, corn-wheat noodles. All the kinds of the noodles can have various short forms e.g. little pearls, granules, short sticks, bars, squares, little rings, etc.

The following examples of the present invention are not intended to be limited to the embodiments disclosed.

### EXAMPLE NO. 1

### Instant Wheat Noodles of Ingredients:

97.2 weight percent of wheat flour, that includes 13% of proteins
0.8 weight percent of dietary fibre preparation, that includes the fibres (particle size) of maximal length 250 micrometers, but 90% less than 120 micrometers
2.0 weight percent of salt,
   were produced in the process of extrusion, consisting of following stages: ingredients mixing, damping, conditioning of the compound, extrusion with formation and cutting of the noodles, drying.

### EXAMPLE NO. 2

### Instant Corn-Wheat Noodles of Ingredients:

58.0 weight percent of wheat flour, that includes 9% of proteins
39.0 weight percent of corn flour, that includes 7% of proteins
3.0 weight percent of dietary fibre preparation, that included the fibres (particle size) of maximal length 250 micrometers, but 90% less that the 120 micrometers,
   were produced like in 1^{st} example.

### EXAMPLE NO. 3

### Instant Buckwheat Noodles of Ingredients:

96.8 weight percent of buckwheat flour, that includes 11% of proteins
1.7 weight percent of dietary fibre preparation, that includes the fibres (particle size) of maximal length 250 micrometers, but 90% less than 120 micrometers
1.5 weight percent of salt,
   were produced like in 1^{st} example.

The instant noodles according to the above invention are not only safe for health, but also reduce product caloric value due to the presence of the dietary fibre, and at the same time enrich the noodles with the valuable ingredient of the healthy diet.

1. The instant noodles, that contain flour or a mix of flours and possibly salt, wherein the instant noodles also contain from 0.5 to 3.0 weight percent of a dietary fibre preparation, that includes the fibres of maximal length 400 micrometers.

2. The instant noodles according to claim 1, wherein the length of the fibres amounts to 250 micrometers.

3. The instant noodles according to claim 1, wherein the length of the 90% quantity of the fibres amounts to 120 micrometers.

4. The instant noodles according to claim 2, wherein the length of the 90% quantity of the fibres amounts to 120 micrometers.
